(19) United States
(12) Patent Application Publication
(10) Pub. No.: US 2018/0081402 A1
(43) Pub. Date: Mar. 22, 2018

(54) Keyboard with Tablet Stand

(71) Applicant: Brydge Global Pte Ltd., Park City, UT (US)

(72) Inventors: Nicholas James Smith, Park City, UT (US); Toby Mander-Jones, Park City, UT (US)

(21) Appl. No.: 15/708,816

(22) Filed: Sep. 19, 2017

Related U.S. Application Data
(60) Provisional application No. 62/396,731, filed on Sep. 19, 2016.

(51) Int. Cl. G06F 1/16

(52) U.S. Cl. CPC G06F 1/1669; G06F 1/1632

(57) ABSTRACT

Provided is a keyboard system having a keyboard, a housing and a tablet stand. The housing includes internal recess disposed within a rear of the housing. The tablet stand is selectively disposed inside the internal recess. In a stored position, the tablet stand is securely received by the internal recess and flush with the housing. The tablet stand further includes a tray slidably coupled to the internal recess, a support pivotally coupled to the tray, and a data and power connection. In various embodiments, the keyboard system is communicatively coupled to the tablet stand via the data connection and at least one additional communication channel.

### CROSS REFERENCE TO RELATED APPLICATIONS

This application claims the benefit of U.S. Provisional Application No. 62/396,731, filed on Sep. 19, 2016, which is hereby incorporated by reference herein in its entirety.

### FIELD OF THE PRESENT TECHNOLOGY

The present disclosure relates generally to keyboards, and more particularly to keyboards having retractable tray stands. Embodiments described herein include a plurality of connectivity methods, and toggling between the connectivity methods to multiple devices.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In various embodiments, the present disclosure is directed to a keyboard system having a keyboard; a housing comprising an internal recess disposed within the housing; and a tablet stand selectively disposed inside the internal recess, the tablet device having a tray slidably coupled to the internal recess, a support pivotally coupled to the tray, a rechargeable internal battery, and multiple connectivity options for a data connection and/or power connection.

### BRIEF DESCRIPTION OF DRAWINGS

Embodiments are illustrated by way of example and not limitation in the figures of the drawings, in which like references indicate similar elements.

FIG. 1 illustrates a top perspective view of an exemplary keyboard system having a tablet stand in an operable position, according to the present disclosure.

FIG. 2 depicts a rear perspective view of the exemplary keyboard system, according to the present disclosure.

FIG. 3 shows a rear perspective view of the exemplary keyboard system having the tablet stand in a stored position, according to the present disclosure.

FIG. 4 illustrates a bottom rear perspective view of the exemplary keyboard system having the tablet stand in the stored position, according to the present disclosure.

FIGS. 5-8 depict left side perspective views of the exemplary keyboard system transitioning from the operable position to the stored position, according to the present disclosure.

FIG. 9 shows a rear view of the exemplary keyboard system having the tablet stand in the stored position, according to the present disclosure.

### DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present disclosure. As such, some of the components may have been distorted from their actual scale for pictorial clarity.

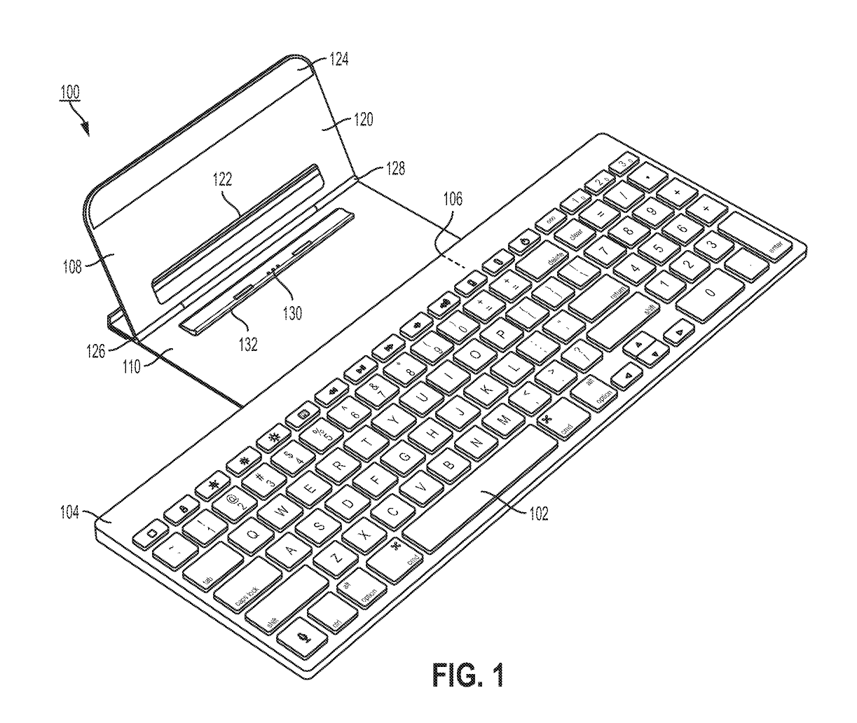

FIG. 1 illustrates an exemplary keyboard system 100 having a keyboard 102, a housing 104 and a tablet stand 108 in an operable position. In various embodiments, the tablet stand 108 supports a tablet device that is in communication with the keyboard 102. A raised edge 132 disposed on the tray 110 may receive a bottom edge of the tablet device while the support 120 props up the tablet device. In certain embodiments, the support 120 includes a pad 124 to protect the tablet device. The tablet device may communicate with the keyboard 102 through a data and/or power connection 130 disposed on the tablet stand 108, through wireless communication via Bluetooth or other suitable wireless protocol, or through a wired connection. In some embodiments, the data and/or power connection 130 is a magnetic coupling. It is to be understood that the keyboard system 100 may be coupled to any suitable type of tablet device, smartphone device or computing device.

In certain embodiments, the keyboard system 100 couples to the tablet device through both the data and/or power connection 130 and through one or more wireless communications, such as Bluetooth or other suitable wireless protocol (referred to collectively as connectivity channels). The keyboard system 100 may similarly couple to a plurality of computing devices, such as the tablet device, smartphone device and a personal computer or other tablet device, simultaneously, for example via at least one first connectivity channel between the tablet device and the keyboard system 100 and via at least one second connectivity channel between the other computing device and the keyboard system 100. It is to be understood that the keyboard system 100 may be connected to one or more tablet devices, smartphone devices or computing devices via the same connectivity channel at the same time (for example, two devices connected via Bluetooth). Furthermore, in various embodiments, the keyboard system 100 toggles between each connectivity method, that is, toggling between typing on each computing device. The keyboard system 100 may toggle between each computing device via actuation of a button or other suitable input method.

In one or more embodiments, the tablet stand 108 includes a tray 110, a support 120, a first hinge 126, a second hinge 128 and the data and/or power connection 130. The tablet stand 108 may be coupled to the housing 104 via the tray 110. In some embodiments, the tray 110 is slidably coupled to an internal track within an internal recess 106 of the housing 104. The tray 110 facilitates the tablet stand 108 retractably sliding into and out of the internal recess 106. The support 120 is pivotally coupled to the tray 110 by the first hinge 126 and the second hinge 128. While two hinges 126, 128 are shown, it is to be understood that the support 120 may be coupled to the tray 110 through any number of hinges or other suitable devices. The support 120 may further include an aperture 122, as will be discussed in greater detail below.

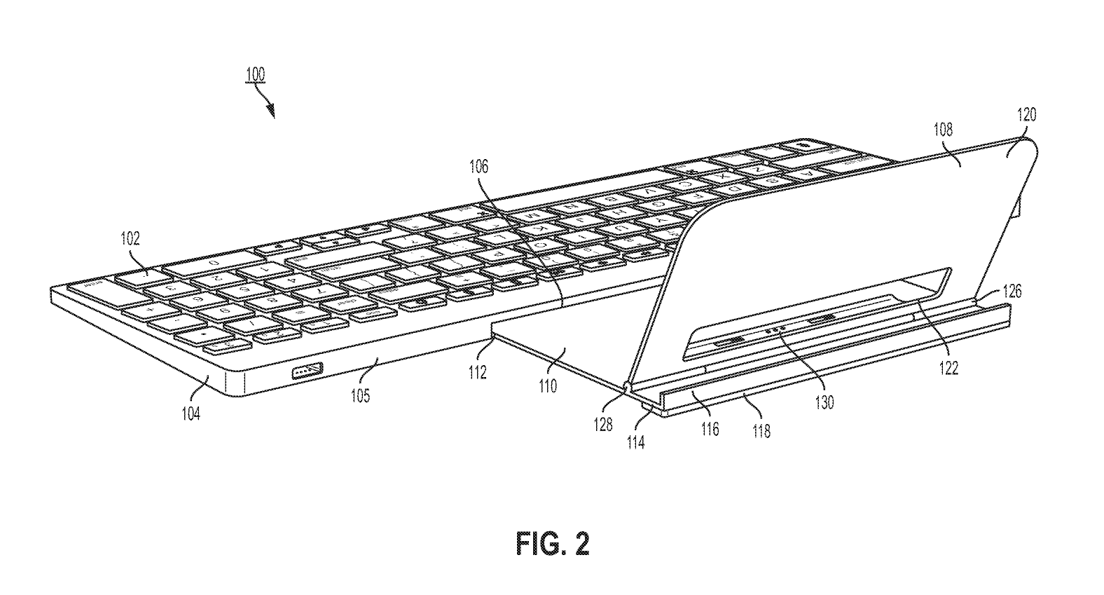

FIG. 2 illustrates a rear perspective view of the exemplary keyboard system 100. In various embodiments, the tray 110 further comprises a first end portion 112 and a second end portion 114. The first end portion 112 is coupled to the internal recess 106 of the housing 104. The second end portion 114 may include an upturned lip 116 and a pad 118. In some embodiments, the upturned lip 116 is flush with a rear face 105 of the housing 104 when the tablet stand 108 is in a stored position. The pad 118 provides support for the tray stand 108 when the keyboard system 100 is resting on a flat surface, and prevents either the flat surface or the tray 110 from being directly in contact.

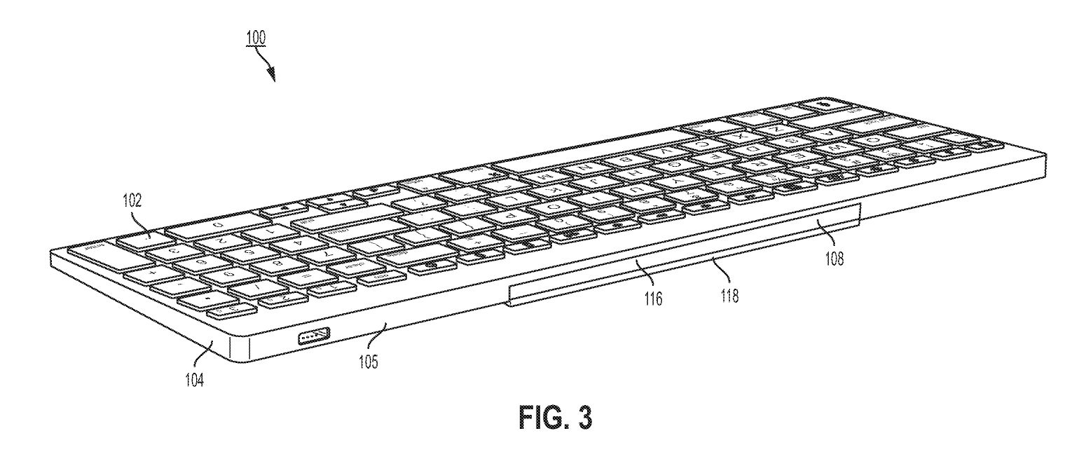

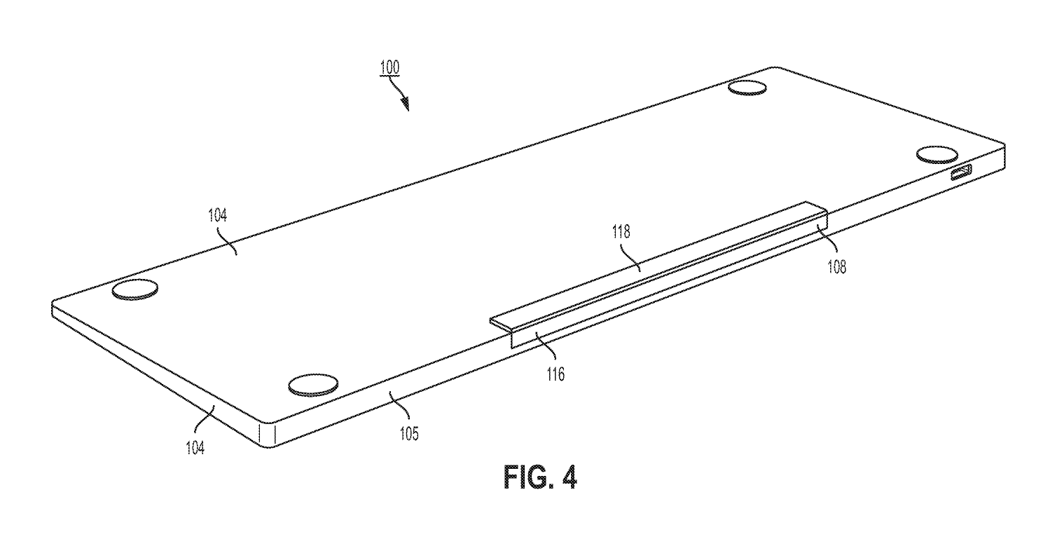

FIGS. 3-4 depict the exemplary keyboard system 100 having the tray stand 108 in a stored position. In the stored position, the tray stand 108 is flush with the housing 104. That is, an exposed portion of the tray stand 108, here the upturned lip 116, is completely flush with a rear face 105 of the housing 104. In addition, a bottom of the housing 104 may include a recess adapted to receive a bottom portion, or pad 118, of the tray stand 108. As shown in greater detail in FIG. 4, the recess contiguously receives and abuts against the pad 118 in the stored position. The pad 118 may either be flush with the bottom of the housing 104, or may extend beyond the bottom to provide further support for the keyboard system. Thus, the tray stand 108 and housing 104 appear as a single construction, aesthetically hiding the tray stand 108.

In the stored position, the tray stand 108 is held in place as to prevent the tray stand 108 from accidentally sliding out while the user transports or otherwise moves the keyboard system 100. The tray stand 108 is held in the hidden, stored position by at least one of a friction fit, a magnet, a latch, or other suitable method of retaining the tray stand 108. In some embodiments, the tray stand 108 is spring loaded and automatically extends outward, away from the internal recess 106, upon the actuation of a latch or button or otherwise release of the tray stand 108. For example, one or more springs may be abuttingly disposed between the first end portion 112 and a wall of the internal recess 106, and compressed in the stored position. Furthermore, one or more torsion springs may be coupled to the hinges 126, 128 and compressed when the support 120 is rotated adjacent to the tray 110. As such, when the tray stand 108 is sliding out of the internal recess 106, either manually or automatically, and the support 120 clears the internal recess 106, the support 120 may spring into the operable position automatically via the torsion springs.

To transition the tablet stand 108 from the operable position (shown in FIGS. 1-2) to the stored position (shown in FIGS. 3-4), a user pivots the support 120 about hinges 126, 128 into a folded position in which the support 120 is adjacent to the tray 110. The user then slides the tablet stand 108 into the internal recess 106. As shown, the upturned lip 116 is completely flush with the rear face 105 of the housing 104. When the tablet stand 108 is in the stored position, the pad 118 provides further support for an upper portion of the keyboard system 100.

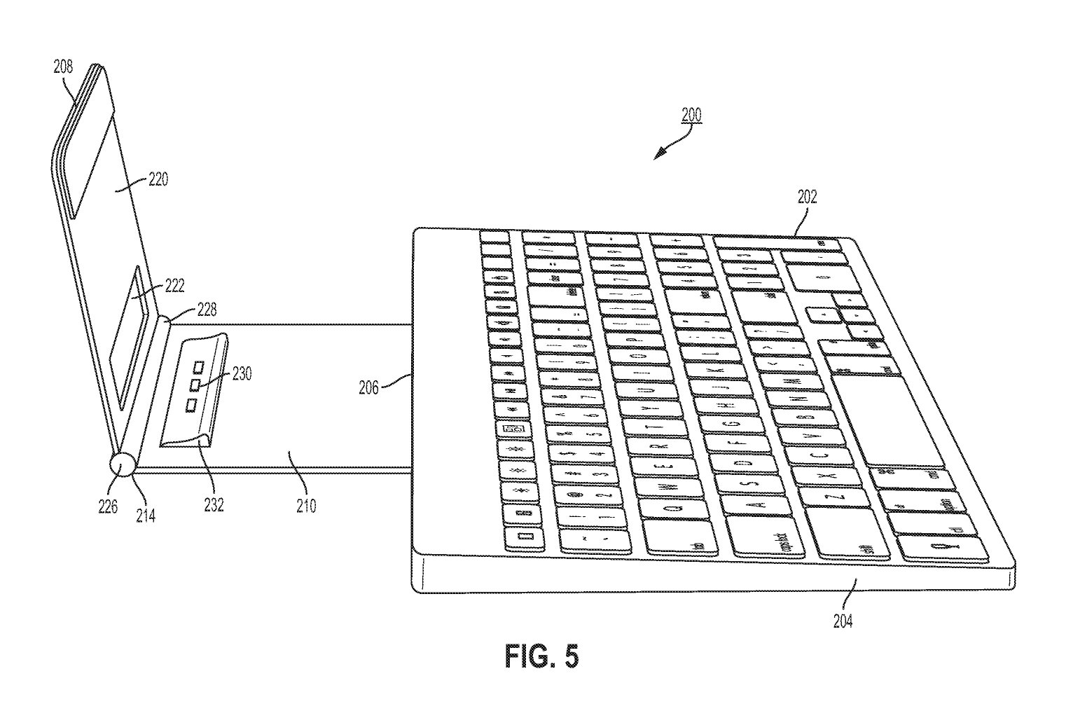

FIGS. 5-8 illustrate another exemplary keyboard system 200 transitioning from an operable position to a stored position. In various embodiments, hinges 226, 228 are disposed at an edge of a second end portion 214 of the tray 210. As will be shown in greater detail, like the upturned edge 216, the hinges 226, 228 may be flush with the rear face 205 of the housing 204 when the tablet stand 208 is in the stored position.

FIG. 5 depicts the tablet stand 208 in the operable position having the support 220 in an unfolded position. A user pivots the support 220 about the hinges 226, 228 into a folded position, in which the support 220 is parallel and adjacent to the tray 210.

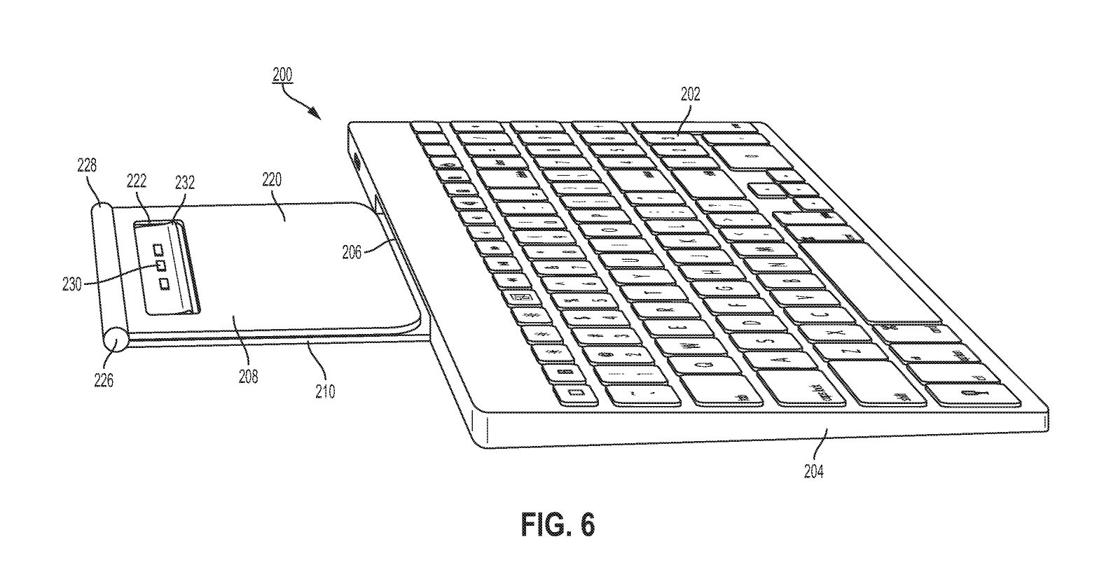

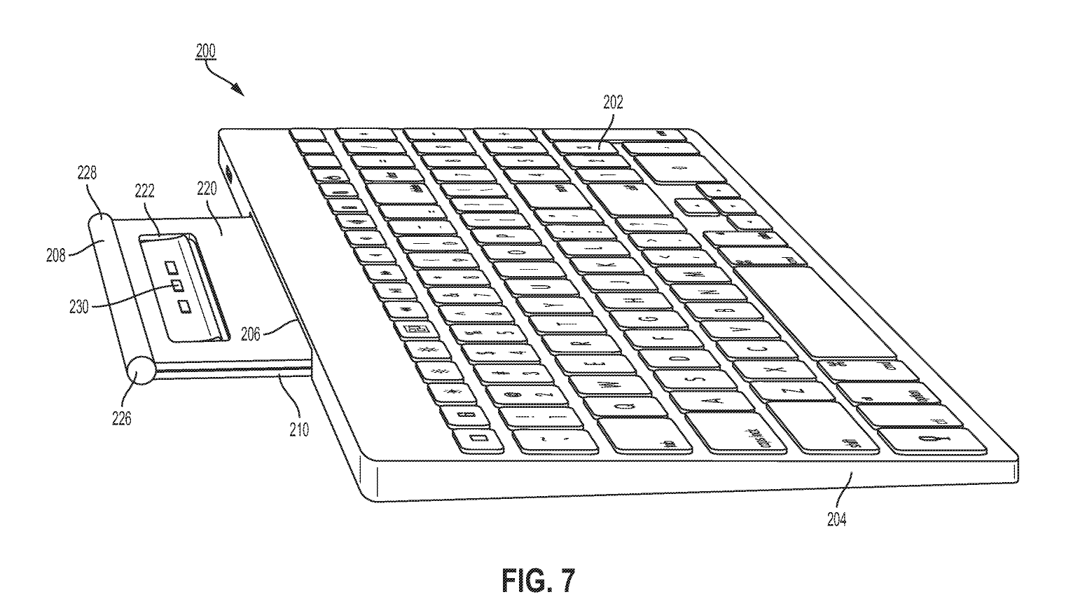

FIG. 6 shows the support 220 in the folded position. As shown, a thickness of the combined support 220 and the tray 210 is less than a thickness of the internal recess 206. The aperture 222 of the support 220 receives the data and/or power connection 230 and the raised edge 232 such that both the data and/or power connection 230 and the raised edge 232 do not interfere with folding of the support 220. The user then slides the tablet stand 208 into the internal recess 206, as shown in FIG. 7.

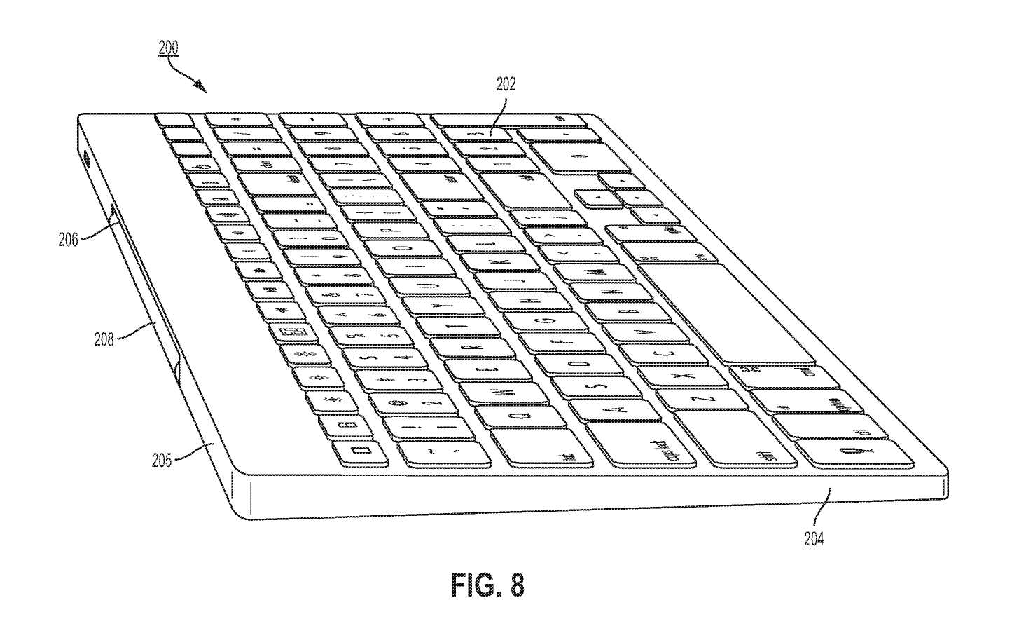

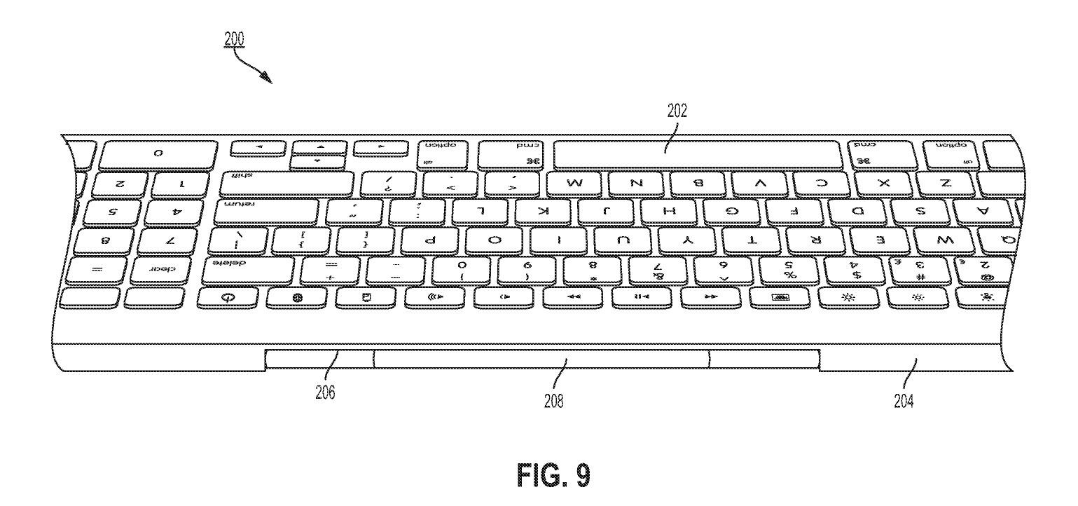

FIGS. 8-9 illustrate the tablet stand 208 selectively disposed within the internal recess 206 in a stored position. As shown, in one or more embodiments the tablet stand 208 is flush with the rear face 205 of the housing 204.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents

1. A keyboard system comprising:
a keyboard;
a housing comprising:
an internal recess disposed within a rear of the housing; and
a tablet stand selectively disposed inside the internal recess, the tablet stand being securely received by the internal recess and flush with the housing in a stored position, the tablet stand comprising:
a tray slidably coupled to the internal recess;
a support pivotally coupled to the tray; and
a data and power connection.

2. The keyboard system of claim 1, wherein the keyboard system is communicatively coupled to the tablet device via the data and power connection and at least one additional communication channel.

3. The keyboard system of claim 2, wherein the keyboard system is communicatively coupled to the tablet device and another computing device simultaneously via a same connectivity channel.

4. A keyboard system, comprising:
a keyboard;
a housing having an internal recess disposed within a rear of the housing; and
a tablet stand selectively disposed inside the internal recess, the tablet stand being securely received by the internal recess by at least one of a friction fit, a magnet, and a latch, the tablet stand being flush with the housing in a stored position, the tablet stand comprising:
a tray slidably coupled to the internal recess;
a support pivotally coupled to the tray; and
a data connection communicatively coupling the keyboard to a computing device.

5. The keyboard system of claim 4, wherein the tray comprises an upturned lip, the upturned lip being flush with the rear of the housing.

6. The keyboard system of claim 4, wherein the internal recess contiguously and abuttingly receives a bottom portion of the tray stand.

7. The keyboard system of claim 6, wherein the bottom portion of the tray stand includes a pad.

8. The keyboard system of claim 4, wherein the tray stand is spring loaded in the stored position.

9. The keyboard system of claim 4, wherein the tray stand further comprises a raised edge adapted to receiving an edge of the computing device.

10. The keyboard system of claim 9, wherein the support of the tray stand includes an aperture adapted to receive the data connection and the raised edge when the tray stand is in the stored position.
